(19) United States
(12) Patent Application Publication
(10) Pub. No.: US 2026/0278387 A1
(43) Pub. Date: Sep. 17, 2026

(54) INFORMATION PROCESSING APPARATUS, INFORMATION PROCESSING SYSTEM, AND INFORMATION PROCESSING METHOD

(71) Applicant: Kioxia Corporation, Tokyo (JP)

(72) Inventors: Asuka MAKI, Kawasaki (JP); Daisuke MIYASHITA, Kawasaki (JP)

(73) Assignee: Kioxia Corporation, Tokyo (JP)

(21) Appl. No.: 19/313,134

(22) Filed: Aug. 28, 2025

(30) Foreign Application Priority Data
Mar. 13, 2025 (JP) 2025-040610

(51) Int. Cl. G06N 3/09; G06N 3/0475

(52) U.S. Cl. CPC G06N 3/09; G06N 3/0475

(57) ABSTRACT

An information processing apparatus includes a first circuit device configured to acquire first information that is an output of a first storage device based on a query that is input to the first storage device, the first storage device is configured to store information to be referred to by a training target model; and a second circuit device configured to output, as training data of the training target model, (1) the query and the first information, (2) an output corresponding to a correct answer to the query among a plurality of outputs of the training target model when the query and the first information are input to the training target model, and (3) an output of the training target model when the query and the first information are input to the training target model.

### CROSS-REFERENCE TO RELATED APPLICATION

This application is based upon and claims the benefit of priority from Japanese Patent Application No. 2025-040610, filed Mar. 13, 2025, the entire contents of which are incorporated herein by reference.

### FIELD

Embodiments described herein relate generally to an information processing apparatus, an information processing system, and an information processing method.

### BACKGROUND

Generative artificial intelligence (AI) is attracting attention. In the generative AI, when a question or a request in words used in daily life is input, it is possible to automatically generate a new sentence, an image, or the like as a response according to the question or the request and output the new sentence, the image, or the like. For example, a large language model (LLM) is used for the generative AI.

The LLM has a large amount of static internal knowledge (general-purpose information) acquired through pre-training, but does not have dynamic external knowledge (non-general-purpose information) such as information used in a specific organization (for example, in-house regulations) and the latest information. Thus, even if a question or a request related to the dynamic external information is given to the LLM, an optimal answer cannot be obtained.

Therefore, a system called a retrieval augmented generation (RAG)-LLM (also referred to as R-LLM) in which dynamic external information is registered in a database separate from the LLM (hereinafter, an external DB) and the external DB is combined with the LLM, is proposed. In RAG-LLM (R-LLM), information obtained by retrieving the external DB based on a question or a request and the question or the request are input to LLM, and an answer is generated and output via LLM.

However, information unrelated to the question or request may be retrieved from the external DB of RAG-LLM. At this time, the LLM may be influenced by information unrelated to the question or the request and may not be able to provide an appropriate answer to the question or the request.

### DESCRIPTION OF THE DRAWINGS

FIG. 1 is a block diagram illustrating a schematic configuration of an information processing system including an information processing apparatus according to an embodiment.

FIG. 2 is a diagram illustrating an operation of the information processing apparatus according to the embodiment.

FIG. 3 is a diagram illustrating a training method of a training target model according to a first comparative example.

FIG. 4 is a diagram illustrating a training method of a training target model according to a second comparative example.

FIG. 5A is a diagram illustrating an outline of a processing operation of the information processing apparatus according to the embodiment.

FIG. 5B is a diagram following FIG. 5A.

FIG. 5C is a diagram following FIG. 5B.

FIG. 5D is a diagram following FIG. 5C.

FIG. 5E is a diagram following FIG. 5D.

FIG. 6A is a diagram illustrating an outline of a processing operation of an information processing apparatus according to a modification example of the embodiment.

FIG. 6B is a diagram following FIG. 6A.

FIG. 6C is a diagram following FIG. 6B.

FIG. 6D is a diagram following FIG. 6C.

FIG. 6E is a diagram following FIG. 6D.

FIG. 7 is a flowchart illustrating a processing operation of the information processing apparatus according to the embodiment.

FIG. 8 is a flowchart of a subroutine called in S4 of FIG. 7.

FIG. 9 is a flowchart of a subroutine called in S5 of FIG. 7.

FIG. 10 is a flowchart of a subroutine called in S6 of FIG. 7.

### DETAILED DESCRIPTION

Embodiments provide an information processing apparatus, an information processing system, and an information processing method that generate training data for a model that can return an appropriate answer to a question or a request.

In general, according to one embodiment, there is provided an information processing apparatus including a first circuit device configured to acquire first information that is an output of a first storage device based on a query that is input to the first storage device, the first storage device is configured to store information to be referred by a training target model; and a second circuit device configured to output, as training data of the training target model, (1) the query and the first information, (2) an output corresponding to a correct answer to the query among a plurality of outputs of the training target model when the query and the first information are input to the training target model, and (3) an output of the training target model when the query and the first information are input to the training target model.

In the following, embodiments of the information processing apparatus, an information processing system, and an information processing method will be described with reference to the drawings. In the following, the main configuration portions of the information processing apparatus and the information processing system are mainly described, but the information processing apparatus and the information processing system may include configuration portions and functions that are not illustrated or described. The following description does not exclude the configuration portions or the functions not illustrated or described.

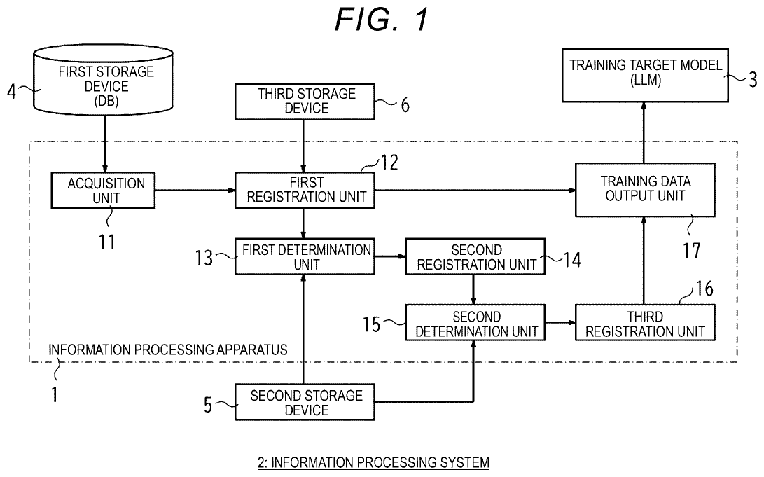

FIG. 1 is a block diagram illustrating a schematic configuration of an information processing system 2 including an information processing apparatus 1 according to an embodiment. As illustrated in FIG. 1, the information processing system 2 according to the embodiment includes the information processing apparatus 1, a training target model 3, and a first storage device 4. The information processing apparatus 1 includes, for example, a general-purpose computer, a central processing unit (CPU), and the like. As will be described later, at least some functions of the information processing apparatus 1 according to the embodiment can be implemented by hardware or software. When at least some functions of the information processing apparatus 1 are implemented by software, the computer or the CPU executes a program in which at least some functions of the information processing apparatus 1 are described, to execute the functions of the information processing apparatus 1.

The information processing apparatus 1 illustrated in FIG. 1 has a function of generating training data for training a large language model (LLM). In the present specification, the LLM to be trained may be referred to as a training target model 3, and the trained LLM may be referred to as a trained model. When a question is given to the trained model, the trained model returns an answer to the question or generates a new sentence, an image, or the like in response to the question. In the following, a question may be referred to as a query. In FIG. 1, the illustration of the trained model is omitted.

In FIG. 1, an example in which the training target model 3 is provided separately from the information processing apparatus 1 is illustrated, but the training target model 3 may be stored in a storage device (not illustrated) provided outside or inside the information processing apparatus 1.

The first storage device 4 stores information that the trained model does not have and executes a retrieval using the information. The stored information is, for example, a plurality of documents related to a query. The trained model acquires information retrieved by the first storage device 4 as necessary, and generates an answer to the question. A disposition location of the first storage device 4 is not limited. For example, the first storage device 4 may be disposed on a cloud connected to the information processing apparatus 1 via a network, or may be disposed in the vicinity of the information processing apparatus 1. The information stored in the first storage device 4 is handled as an external DB of the information processing apparatus 1.

In addition, a plurality of storage devices (for example, a second storage device 5 and a third storage device 6) are connected to the information processing apparatus 1 illustrated in FIG. 1 in addition to the first storage device 4 described above. The information stored in the second storage device 5 and the third storage device 6 will be described below. At least one of the second storage device 5 and the third storage device 6 may be built into the information processing apparatus 1.

The information processing apparatus 1 illustrated in FIG. 1 includes an acquisition unit 11, a first registration unit 12, a first determination unit 13, a second registration unit 14, a second determination unit 15, a third registration unit 16, and a training data output unit 17. Among these, the acquisition unit 11 and the training data output unit 17 are necessary configuration blocks in the information processing apparatus 1 according to the embodiment, and the other configuration blocks can be freely integrated or omitted.

The acquisition unit 11 includes a circuit for communicating information with the first storage device 4. The acquisition unit 11 acquires a response (first information) to the query output from the first storage device 4 when the query is input to the first storage device 4. The response to the query acquired by the acquisition unit 11 is, for example, information such as a document related to the query. An input unit that inputs the query to the first storage device 4 may be provided separately from the acquisition unit 11. The acquisition unit 11 is a circuit device capable of communicating with the first storage device 4. In the present specification, the acquisition unit 11 may be referred to as a first circuit device.

The training data output unit 17 includes a circuit for communicating information with the training target model 3. The training data output unit 17 outputs training data of the training target model 3. The training data includes the query and information acquired by the acquisition unit 11, an output determined to be a correct answer to the query out of outputs of the training target model 3 when the query and information acquired by the acquisition unit 11 are input into the training target model 3, and an output of the training target model 3 which may include an output corresponding to an incorrect answer to the query when the query and information acquired by the acquisition unit 11 are input into the training target model 3. The training data output unit 17 is a circuit device capable of communicating with the training target model 3. In the present specification, the training data output unit 17 may be referred to as a second circuit device.

The training data output unit 17 outputs, as the training data, a set of (1) the query and information acquired by the acquisition unit 11, (2) an output determined to be a correct answer to the query out of the plurality of outputs of the training target model 3 when the query and information acquired by the acquisition unit 11 are input into the training target model 3, and (3) an output of the training target model 3 which may include an output corresponding to an incorrect answer to the query when the query and information acquired by the acquisition unit 11 are input into the training target model 3. By training the training target model 3 using such training data, it is expected that a correct answer is obtained from the trained model even when information that may be unrelated to the query is input to the trained model.

The first registration unit 12 registers an output of the training target model 3 when the query and the information acquired by the acquisition unit 11 are input to the training target model 3. The output of the training target model 3 registered in the first registration unit 12 may include an answer that is not a correct answer (that is, an incorrect answer) to the query, which is output from the training target model 3. The first registration unit 12 can be configured as a circuit device using an electric, optical, or magnetic storage element such as a register, a memory, or a disk. That is, the first registration unit 12 is an example of a storage circuit. In the present specification, the first registration unit 12 may be referred to as a first storage circuit.

The first determination unit 13 determines whether an output of the training target model 3 when the query and the information acquired by the acquisition unit 11 are input to the training target model 3 is a correct answer to the query. The first determination unit 13 may perform the determination processing by using the training target model 3, or may perform the determination processing by using a trained model that is separately provided from the training target model 3. The first determination unit 13 is implemented by a circuit device such as a computer or a CPU that executes dedicated hardware or a program. In the present specification, the first determination unit 13 may be referred to as a third circuit device.

The second registration unit 14 registers an output of the first storage device 4 corresponding to the output of the training target model 3 determined to be a correct answer to the query by the first determination unit 13. That is, the second registration unit 14 registers the output of the first storage device 4 used when obtaining the output of the training target model 3 determined to be a correct answer to the query by the first determination unit 13. The second registration unit 14 can be configured as a circuit device using an electric, optical, or magnetic storage element such as a register, a memory, or a disk. That is, the second registration unit 14 is an example of the storage circuit. In the present specification, the second registration unit 14 may be referred to as a second storage circuit.

The second determination unit 15 determines whether an output of the training target model 3 when a query and an output of the first storage device 4 registered in the second registration unit 14 are input to the training target model 3 is a correct answer to the query. The second determination unit 15 may perform the determination processing by using the training target model 3, or may perform the determination processing by using a trained model that is separately provided from the training target model 3. The second determination unit 15 is implemented by a circuit device such as a computer or a CPU that executes dedicated hardware or a program. In the present specification, the second determination unit 15 may be referred to as a fourth circuit device.

The third registration unit 16 registers an output of the training target model 3 determined to be a correct answer to the query by the second determination unit 15. The third registration unit 16 can be configured as a circuit device using an electric, optical, or magnetic storage element such as a register, a memory, or a disk. That is, the third registration unit 16 is an example of the storage circuit. In the present specification, the third registration unit 16 may be referred to as a third storage circuit.

The training data output unit 17 described above outputs, as the training data of the training target model 3, the query and the information acquired by the acquisition unit 11, the output of the training target model 3 registered in the first registration unit 12, and the output of the training target model 3 registered in the third registration unit 16.

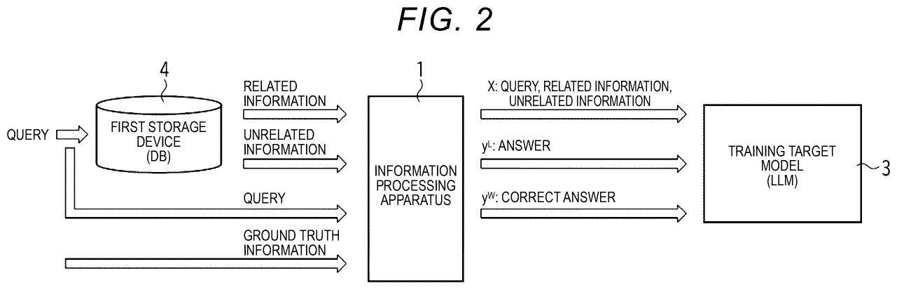

FIG. 2 is a diagram illustrating an operation of the information processing apparatus 1 according to the embodiment. When a query is input to the first storage device 4, the information processing apparatus 1 acquires the query input to the first storage device 4 and a response to the query output from the first storage device 4, and performs training of the training target model 3. The response to the query output from the first storage device 4 includes a response related to the query (related information) and a response unrelated to the query (unrelated information). As a result, when the trained model after the training of the training target model 3 is completed and the first storage device 4 are used for inference, it is expected that a correct answer is obtained from the trained model even when information that may include information unrelated to the query is input to the trained model.

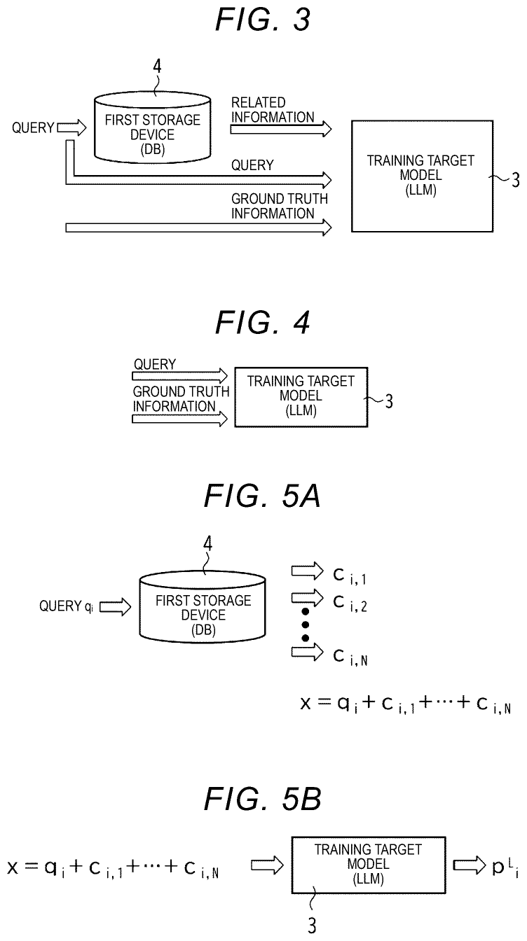

FIG. 3 is a diagram illustrating a training method of the training target model 3 according to a first comparative example. In the first comparative example, training is performed using training data that does not include unrelated information for the query output from the first storage device 4. Therefore, in the inference stage using the trained model trained using such training data, when the first storage device 4 outputs a response unrelated to the query, the trained model may output an answer unrelated to the query due to the influence.

FIG. 4 is a diagram illustrating a training method of the training target model 3 according to a second comparative example. In the second comparative example, the training target model 3 is trained by directly inputting the training data including the query and the information (ground truth information) corresponding to the correct answer to the query into the training target model 3 without using the response to the query output from the first storage device 4. Therefore, in the inference stage using the trained model trained using such training data, an appropriate answer cannot be provided for a query requiring knowledge not possessed by the trained model.

The information processing apparatus 1 according to an embodiment generates training data in the format of (x, y^{W}, y^{L}). x is a query and a retrieval result of the first storage device 4 for the query (an output of the first storage device 4 acquired by the acquisition unit 11). x may include unrelated information for the query. y^{W} is a correct answer to a query output from the training target model 3 and may be represented as p^{W}_{i,j}. y^{L} is the answer output from the training target model 3 when x is input to the training target model 3, and may be represented as p^{L}_{i,j}.

In the present embodiment, it is assumed that a set (qᵢ, gᵢ) of the ground truth information gᵢ for the query qᵢ is prepared in advance. It is assumed that the ground truth information gᵢ is stored in advance in, for example, the second storage device 5.

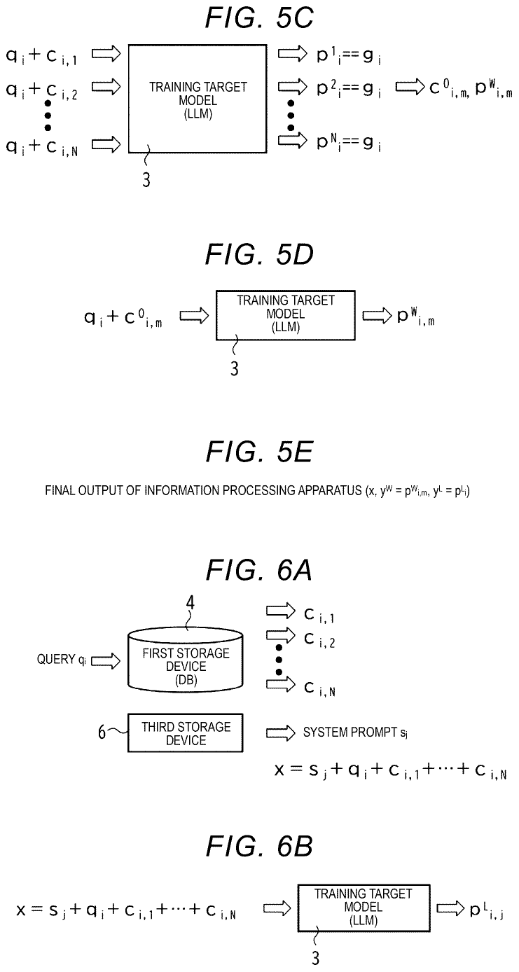

FIGS. 5A, 5B, 5C, 5D, and 5E are diagrams illustrating an outline of a processing operation of the information processing apparatus 1 according to the embodiment. First, as illustrated in FIG. 5A, the first storage device 4 is retrieved by using the query qᵢ given by the user, and an output of the first storage device 4 indicating a retrieval result is acquired by the acquisition unit 11. FIG. 5A illustrates an example in which a plurality of outputs c_{i,1}, . . . , and c_{i,N} are read as retrieval results from the first storage device 4 for the query qᵢ and acquired. Here, N is an integer of 1 or more.

Next, as illustrated in FIG. 5B, the query qᵢ and all the outputs c_{i,1}, . . . , and c_{i,N} of the first storage device 4 for the query qᵢ are input to the training target model 3 as a set. All the outputs c_{i,1}, . . . , and c_{i,N} may include information not related to the query qᵢ. Here, a character string x (in the present specification, represented as x=qᵢ+c_{i,1}+ . . . +c_{i,N}) obtained by connecting a character string of the query qᵢ and a character strings of all the outputs c_{i,1}, . . . , and c_{i,N} of the first storage device 4 is input to the training target model 3. The output p^{L}ᵢ of the training target model 3 at this time indicates the output of the training target model 3 with respect to the character string x. Since the character string x may include information not related to the query qᵢ, the output p^{L}ᵢ of the training target model 3 may not be a correct answer to the query qᵢ.

Next, as illustrated in FIG. 5C, a plurality of sets (qᵢ+c_{i,1}), (qᵢ+c_{i,2}), . . . , and (qᵢ+c_{i,N}) are prepared, each of which is a set in which the query qᵢ and each of the outputs c_{i,1}, . . . , and c_{i,N} of the first storage device 4 are combined into a separate set. All the outputs that match the ground truth information gᵢ are retrieved among the outputs p^{T} of the training target model 3 when these sets are subsequently input to the training target model 3. For example, when there are N outputs of the first storage device 4, and L of the N outputs match the ground truth information gᵢ, L matching outputs c^{O}_{i,m} of the first storage device 4 and the outputs p^{W}_{i,m} of the training target model 3 are extracted (1≤m≤L, m is an integer).

Next, as illustrated in FIG. 5D, by inputting each of one or more sets (qᵢ+c^{O}_{i,m}) to the training target model 3, one or more outputs p^{W}_{i,m} are output from the training target model 3. The outputs p^{W}_{i,m} are outputs of the training target model 3 for the query qᵢ that outputs the ground truth information gᵢ, and is an answer assumed to be correct for the query qᵢ.

Finally, the training data output unit 17 outputs the training data (x, y^{W}=p^{W}_{i,m}, y^{L}=p^{L}ᵢ) as a set, as illustrated in FIG. 5E.

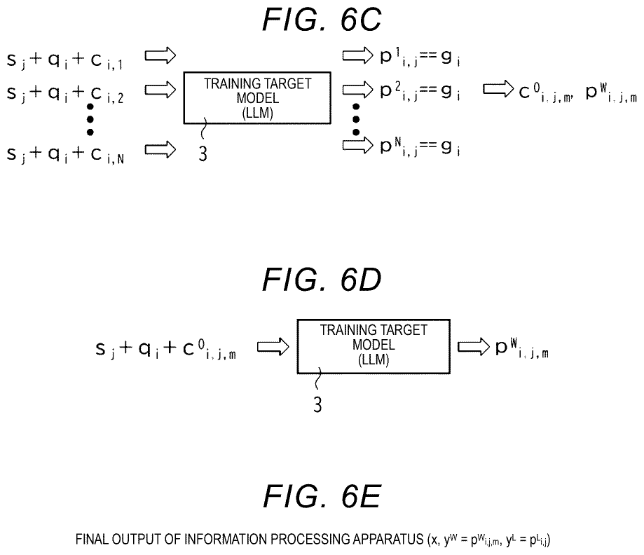

FIGS. 6A, 6B, 6C, 6D, and 6E are diagrams illustrating a processing operation of the information processing apparatus 1 according to a modification example of the embodiment. In an existing LLM, a system prompt may be input to the LLM along with a query so that the LLM provides a desired response. The system prompt is instruction information or the like input to the LLM to restrict the output of the LLM. The modification example illustrated in FIGS. 6A to 6E illustrates an example in which a query qᵢ and a system prompt sⱼ are input to the training target model 3 which is the LLM. The system prompt sⱼ is stored, for example, in the third storage device 6 in advance.

More specifically, as illustrated in FIG. 6A, a query qᵢ is input to the first storage device 4. At this time, the first storage device 4 outputs c_{i,1}, . . . , and c_{i,N}. In addition, the system prompt sⱼ is acquired from the third storage device 6.

Next, as illustrated in FIG. 6B, a character string x=sⱼ+qᵢ+c_{i,1}+ . . . +c_{i,N} obtained by connecting the system prompt sⱼ, the query qᵢ, and all the outputs c_{i,1}, . . . , and c_{i,N} of the first storage device 4 is input to the training target model 3. As a result, the training target model 3 outputs p^{L}_{i,j}. The output p^{L}_{i,j} of the training target model 3 at this time indicates the output of the training target model 3 with respect to the character string x. Since the character string x may include information not related to the query qᵢ, the output p^{L}_{i,j} of the training target model 3 may not be a correct answer to the query qᵢ.

Next, as illustrated in FIG. 6C, the output c^{O}_{i,j,m} of the first storage device 4 in which the output p^{T} of the training target model 3 is the ground truth information gᵢ and an output p^{W}_{i,j,m} of the training target model 3 are extracted from a set of the system prompt sⱼ, the query qᵢ, and all the outputs c_{i,1}, . . . , and c_{i,N} of the first storage device 4, respectively. As illustrated in FIG. 6D, a character string (sⱼ+qᵢ+c^{O}_{i,j,m}) obtained by connecting the system prompt sⱼ, the query qᵢ, and the output c^{O}_{i,j,m} of the first storage device 4 is input to the training target model 3, and p^{W}_{i,j,m} is output from the training target model 3. Finally, as illustrated in FIG. 6E, the training data output unit 17 outputs the training data (x, y^{W}=p^{W}_{i,j,m}, and y^{L}=p^{L}_{i,j}).

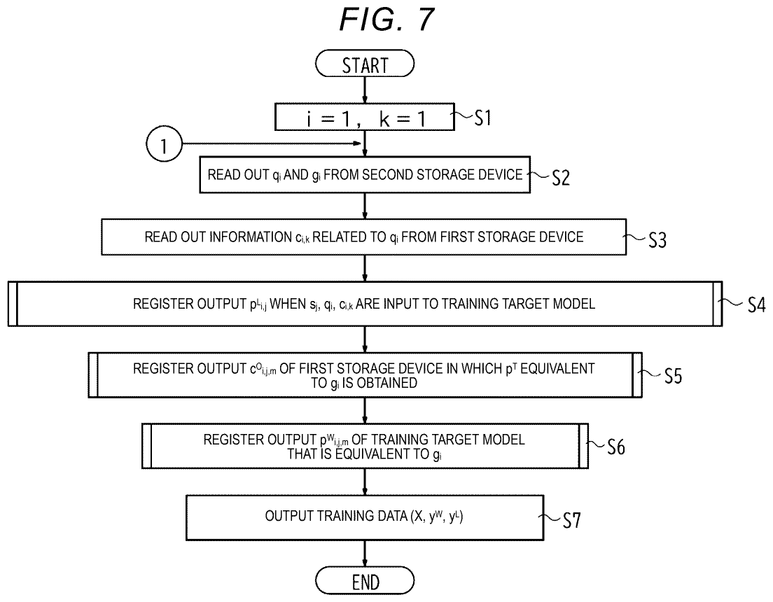

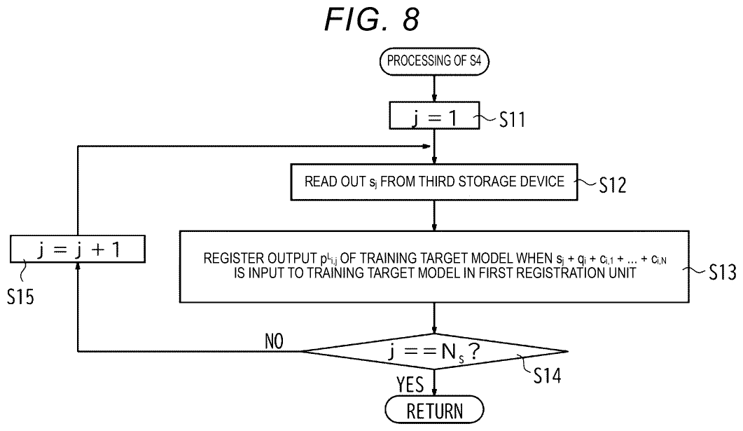

FIG. 7 is a flowchart illustrating a processing operation of the information processing apparatus 1 according to the modification example of the embodiment, and FIGS. 8 to 10 are subroutines called from the flowchart of FIG. 7. In the following, the processing operation of the information processing apparatus 1 according to the present embodiment will be described with reference to FIGS. 7 to 10.

First, the information processing apparatus 1 initializes a variable i and a variable k to 1 (S1). The variable i is a variable for identifying the query qᵢ, and the variable k is a variable for identifying the output c_{i,k} of the first storage device 4 related to the query qᵢ.

Next, the information processing apparatus 1 reads out the query qᵢ and correct answer (hereinafter, ground truth information) gᵢ for a query qᵢ from the second storage device 5 (S2).

Next, the information processing apparatus 1 reads out Nₖ pieces of information c_{i,k} related to the query qᵢ from the first storage device 4 (S3). Nₖ is, for example, an integer of 1 or more (1≤k≤Nₖ, k is an integer).

Next, the information processing apparatus 1 registers, in the first registration unit 12, the output p^{L}_{i,j} of the training target model 3 when the system prompt sⱼ, the query qᵢ, and the information c_{i,k} read from the first storage device 4 are input to the training target model 3 (S4). The variable j is a variable for identifying the system prompt (j is an integer of 1 or more). The detailed processing of S4 will be described with reference to a subroutine of FIG. 8 which will be described later. Since the information c_{i,k} may include information not related to the query qᵢ, the output p^{L}_{i,j} of the training target model 3 may not be a correct answer to the query qᵢ.

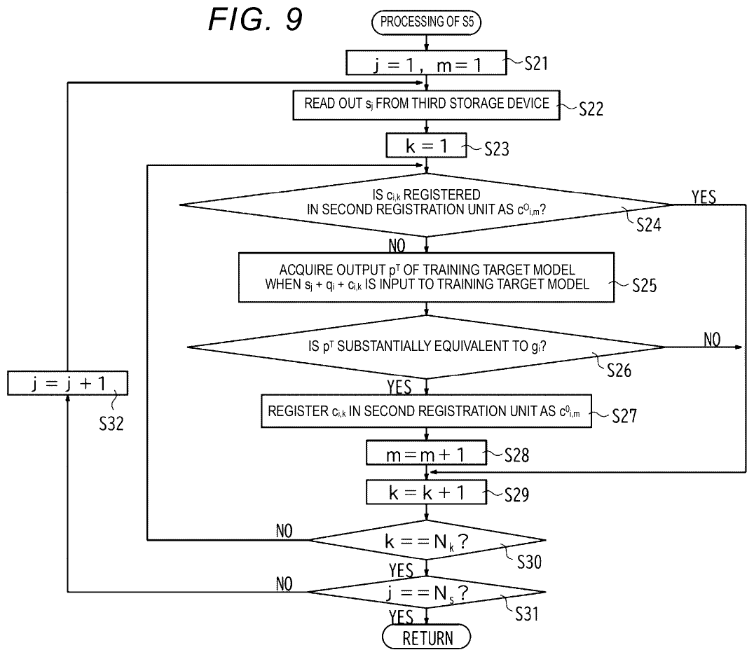

Next, the information processing apparatus 1 registers, in the second registration unit 14, the output c^{O}_{i,j,m} of the first storage device 4 in which the output P^{W}_{i,j} (p^{T}) of the training target model 3 that is substantially equivalent to the ground truth information gᵢ is obtained when input is performed together with the query qᵢ among the information c_{i,k} read from the first storage device 4 (S5). The detailed processing of S5 will be described with reference to a subroutine of FIG. 9 which will be described later.

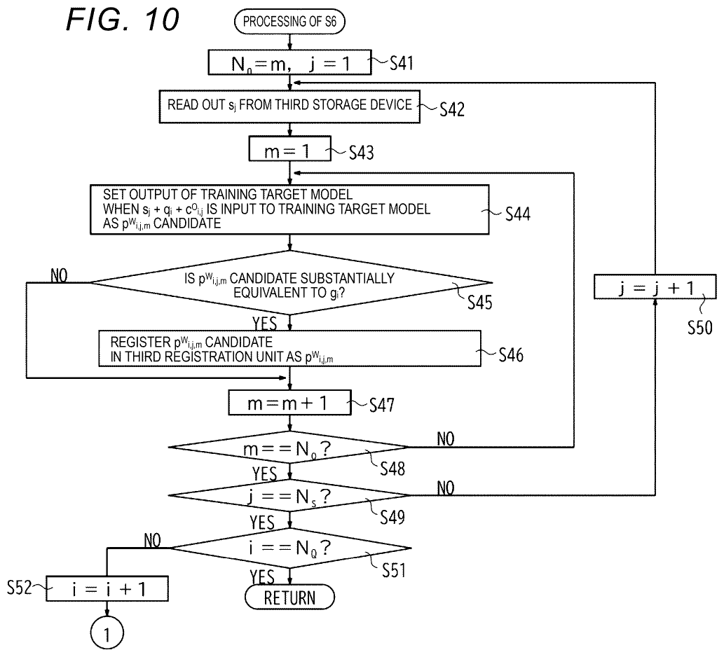

Next, the information processing apparatus 1 registers, in the third registration unit 16, the output P^{W}_{i,j,m} of the training target model 3 that is substantially equivalent to the ground truth information gᵢ (S6). The output P^{W}_{i,j,m} of the training target model 3 is a correct answer to the query qᵢ. The detailed processing of S6 will be described with reference to a subroutine of FIG. 10 which will be described later.

Finally, the information processing apparatus 1 outputs the training data (x, y^{W}, y^{L}) for training the training target model 3 (S7). x, y^{W}, and y^{L} are represented by the following Equations (1) to (3).

$$x = {s}_{j} + {q}_{i} + {c}_{i , 1} + … + {c}_{i , N} \qquad ( 1 )$$

$${y}^{W} = {p}_{i , j}^{W} \qquad ( 2 )$$

$${y}^{L} = {p}_{i , j}^{L} \qquad ( 3 )$$

As described above, the information processing apparatus 1 according to the present embodiment uses, as the training data of the training target model 3, not only the correct answer y^{W} to the query qᵢ but also y^{L} that may not include the correct answer.

FIG. 8 is a flowchart of the subroutine called in S4 of FIG. 7. First, the variable j for identifying the system prompt sⱼ is initialized to 1 (S11).

Next, a j-th system prompt sⱼ is read from the third storage device 6 (S12). At this time, outputs c_{i,1}, . . . , and c_{i,N} of the first storage device 4 when the query qᵢ is input to the first storage device 4 are acquired.

Next, the output p^{L}_{i,j} of the training target model 3 when sⱼ+qᵢ+c_{i,1}+ . . . +c_{i,N} is input to the training target model 3 is registered in the first registration unit 12 (S13).

Next, it is determined whether the variable j matches the total number Nₛ of the system prompts sⱼ stored in the third storage device 6 (S14). When S14 is NO, the variable j is incremented by 1 (S15), and the processing from S12 onward is repeated. When S14 is YES, the processing of S4 in FIG. 7 ends, and the processing of S5 is performed.

FIG. 9 is a flowchart of the subroutine called in S5 of FIG. 7. First, the variable j and a variable m are initialized to 1 (S21). The variable m is a variable that identifies the output c^{O}_{i,j,m} of the first storage device 4 corresponding to the correct answer output from the training target model 3 among the outputs c_{i,j} of the first storage device 4.

Next, the j-th system prompt sⱼ is read from the third storage device 6 (S22).

Next, the variable k is initialized to 1 (S23). Next, it is determined whether the output c_{i,k} of the first storage device 4 is registered in the second registration unit 14 as c^{O}_{i,m} (S24). When S24 is NO, the output p^{T} of the training target model 3 when sⱼ+qᵢ+c_{i,k} is input to the training target model 3 is acquired (S25).

Next, it is determined whether the output p^{T} of the training target model 3 is substantially equivalent to the ground truth information gᵢ (S26). The determination processing in S26 is performed by the first determination unit 13. When S26 is YES, c_{i,k} is registered in the second registration unit 14 as c^{O}_{i,m} (S27).

Next, the variable m is incremented by 1 (S28). When S24 is YES, when S26 is NO, or when the processing of S28 ends, the variable k is incremented by 1 (S29).

Next, it is determined whether the variable k matches the total number Nₖ of pieces of information c_{i,k} (S30). When S30 is NO, the processing from S24 onward is repeated. When S30 is YES, it is determined whether the variable j matches the total number Nₛ of system prompts stored in the third storage device 6 (S31). When S31 is NO, the variable j is incremented by 1 (S32), and the processing from S22 onward is repeated. When S31 is YES, the processing of S5 in FIG. 7 ends, and the processing of S6 is performed.

FIG. 10 is a flowchart of the subroutine called in S6 of FIG. 7. First, the number N_{O} of outputs of the first storage device 4 when the output p^{T} of the training target model 3 is the correct answer to the query qᵢ is initialized to the variable m, and the variable j is initialized to 1 (S41). The variable m at this time point is the total number N_{O} of outputs of the first storage device 4 when the output p^{T} of the training target model 3 is a correct answer.

Next, the j-th system prompt sⱼ is read from the third storage device 6 (S42). Next, the variable m is initialized to 1 (S43). Next, the output of the training target model 3 when sⱼ+qᵢ+c^{O}_{i,j} is input to the training target model 3 is set as a p^{W}_{i,j,m} candidate (S44).

Next, it is determined whether the p^{W}_{i,j,m} candidate is substantially equivalent to the ground truth information gᵢ (S45). The determination processing in S45 is performed by the second determination unit 15. When S45 is YES, the p^{W}_{i,j,m} candidate is registered in the third registration unit 16 as p^{W}_{i,j,m} (S46).

Next, the variable m is incremented by 1 (S47). Next, it is determined whether the variable m matches the number N_{O} (S48). When S48 is NO, the processing from S44 onward is repeated.

When S48 is YES, it is determined whether the variable j matches the total number Nₛ of the system prompts sⱼ (S49). When S49 is NO, the variable j is incremented by 1 (S50), and the processing from S42 onward is repeated.

When S49 is YES, it is determined whether the variable i matches the total number N_{Q} of queries (S51). When S51 is NO, the variable i is incremented by 1, and the processing from S2 of FIG. 7 onward is repeated. When S51 is YES, the processing of S6 in FIG. 7 ends, and the processing of S7 is performed.

As described above, in the information processing apparatus 1 according to the embodiment, the training target model 3 provides an answer to the query by using the information stored in the first storage device 4, which has information not possessed by the training target model 3. At this time, not only the correct answer y^{W} output by the training target model 3 when the query and the response to the query output from the first storage device 4 are input to the training target model 3, but also the output y^{L} of the training target model 3 when the query and the response to the query output from the first storage device 4 are input to the training target model 3 is provided in the training data of the training target model 3. As a result, it is expected that a correct answer is obtained from the trained model even when information that may include information unrelated to the query is input to the trained model.

At least a part of the information processing apparatus 1 and the information processing system 2 described in the above embodiment may be configured with hardware or may be configured with software. When the information processing apparatus 1 and the information processing system 2 are configured with software, a program for implementing at least a part of the functions of the information processing apparatus 1 and the information processing system 2 may be stored in a recording medium such as a flexible disk or a CD-ROM, and may be read and executed by a computer. The recording medium is not limited to a removable medium such as a magnetic disk or an optical disk but may be a fixed recording medium such as a hard disk device or a memory.

In addition, a program for implementing at least a part of the functions of the information processing apparatus 1 and the information processing system 2 may be distributed via a communication line such as the Internet (including wireless communication). Further, the program may be distributed via a wired line or a wireless line such as the Internet or stored in a recording medium in a state in which the program is encrypted, modulated, or compressed.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information processing apparatus comprising:
a first circuit device configured to acquire first information that is an output of a first storage device based on a query that is input to the first storage device, the first storage device being configured to store information to be referred to by a training target model; and
a second circuit device configured to output, as training data of the training target model, (1) the query and the first information, (2) an output corresponding to a correct answer to the query among a plurality of outputs of the training target model when the query and the first information are input to the training target model, and (3) an output of the training target model when the query and the first information are input to the training target model.

2. The information processing apparatus according to claim 1, further comprising:
a first storage circuit configured to register the output of the training target model when the query and the first information are input to the training target model;
a third circuit device configured to determine whether the output of the training target model is the correct answer to the query, when the query and the first information are input to the training target model;
a second storage circuit configured to register second information, which is an output of the first storage device corresponding to the output of the training target model determined to be the correct answer to the query by the third circuit device;
a fourth circuit device configured to determine whether an output of the training target model is the correct answer to the query, when the query and the second information registered in the second storage circuit are input to the training target model; and
a third storage circuit configured to register the output of the training target model determined to be the correct answer to the query by the fourth circuit device,
wherein the second circuit device is configured to output, as the training data of the training target model, the query and the first information, the output of the training target model registered in the first storage circuit, and the output of the training target model registered in the third storage circuit.

3. The information processing apparatus according to claim 2,
wherein the third circuit device and the fourth circuit device are each configured to determine whether the output of the training target model is the correct answer to the query by comparing the output of the training target model with ground truth information for the query, which is read from a second storage device configured to store the ground truth information.

4. The information processing apparatus according to claim 2,
wherein the first storage circuit is configured to register an output of the training target model when a system prompt, which is instruction information for the training target model, the query, and the first information are input to the training target model,
the third circuit device is configured to determine whether the output of the training target model is the correct answer to the query, when the system prompt, the query, and the first information are input to the training target model,
the second storage circuit is configured to register third information, which is the output of the first storage device corresponding to the output of the training target model determined to be the correct answer to the query by the third circuit device,
the fourth circuit device is configured to determine whether an output of the training target model is the correct answer to the query, when the system prompt, the query, and the third information registered in the second storage circuit are input to the training target model,
the third storage circuit is configured to register the output of the training target model determined to be the correct answer to the query by the fourth circuit device, and
the second circuit device is configured to output, as the training data of the training target model, the system prompt, the query, the first information, the output of the training target model registered in the first storage circuit, and the output of the training target model registered in the third storage circuit.

5. The information processing apparatus according to claim 2,
wherein the first circuit device is configured to acquire a plurality of outputs of the first storage device with respect to the query from the first storage device,
the first storage circuit is configured to register a plurality of outputs of the training target model when the query and the plurality of outputs are input to the training target model, and
the third circuit device is configured to determine, for each of the plurality of outputs, whether an output of the training target model is the correct answer to the query, when the query and each of the plurality of outputs are set as separate sets and each set is input to the training target model.

6. The information processing apparatus according to claim 1,
wherein the training target model is a retrieval augmented generation large language model (RAG-LLM).

7. An information processing system comprising:
a first storage device configured to store information to be referred to by a training target model; and
an information processing apparatus configured to generate training data of the training target model,
wherein the information processing apparatus includes:
a first circuit device configured to acquire first information that is an output of the first storage device based on a query that is input to the first storage device; and
a second circuit device configured to output, as training data of the training target model, (1) the query and the first information, (2) an output corresponding to a correct answer to the query among a plurality of outputs of the training target model when the query and the first information are input to the training target model, and (3) an output of the training target model when the query and the first information are input to the training target model.

8. The information processing system according to claim 7, wherein the information processing apparatus further includes:
a first storage circuit configured to register the output of the training target model when the query and the first information are input to the training target model;
a third circuit device configured to determine whether the output of the training target model is the correct answer to the query, when the query and the first information are input to the training target model;
a second storage circuit configured to register second information, which is an output of the first storage device corresponding to the output of the training target model determined to be the correct answer to the query by the third circuit device;
a fourth circuit device configured to determine whether an output of the training target model is the correct answer to the query, when the query and the second information registered in the second storage circuit are input to the training target model; and
a third storage circuit configured to register the output of the training target model determined to be the correct answer to the query by the fourth circuit device,
wherein the second circuit device is configured to output, as the training data of the training target model, the query and the first information, the output of the training target model registered in the first storage circuit, and the output of the training target model registered in the third storage circuit.

9. The information processing system according to claim 8,
wherein the third circuit device and the fourth circuit device are each configured to determine whether the output of the training target model is the correct answer to the query by comparing the output of the training target model with ground truth information for the query, which is read from a second storage device configured to store the ground truth information.

10. The information processing system according to claim 8,
wherein the first storage circuit is configured to register an output of the training target model when a system prompt, which is instruction information for the training target model, the query, and the first information are input to the training target model,
the third circuit device is configured to determine whether the output of the training target model is the correct answer to the query, when the system prompt, the query, and the first information are input to the training target model,
the second storage circuit is configured to register third information, which is the output of the first storage device corresponding to the output of the training target model determined to be the correct answer to the query by the third circuit device,
the fourth circuit device is configured to determine whether an output of the training target model is the correct answer to the query, when the system prompt, the query, and the third information registered in the second storage circuit are input to the training target model,
the third storage circuit is configured to register the output of the training target model determined to be the correct answer to the query by the fourth circuit device, and
the second circuit device is configured to output, as the training data of the training target model, the system prompt, the query, the first information, the output of the training target model registered in the first storage circuit, and the output of the training target model registered in the third storage circuit.

11. The information processing system according to claim 8,
wherein the first circuit device is configured to acquire a plurality of outputs of the first storage device with respect to the query from the first storage device,
the first storage circuit is configured to register a plurality of outputs of the training target model when the query and the plurality of outputs are input to the training target model, and
the third circuit device is configured to determine, for each of the plurality of outputs, whether an output of the training target model is the correct answer to the query, when the query and each of the plurality of outputs are set as separate sets and each set is input to the training target model.

12. The information processing system according to claim 7, wherein the training target model is a retrieval augmented generation large language model (RAG-LLM).

13. An information processing method for an information processing apparatus configured to generate training data of a training target model, the method comprising:
inputting a query to a first storage device storing information to be referred to by the training target model;
acquiring first information that is an output of the first storage device based on the query that is input to the first storage device; and
outputting, as the training data of the training target model, (1) the query and the first information, (2) an output corresponding to a correct answer to the query among a plurality of outputs of the training target model when the query and the first information are input to the training target model, and (3) an output of the training target model when the query and the first information are input to the training target model.

14. The information processing method according to claim 13, wherein the training target model is a retrieval augmented generation large language model (RAG-LLM).

15. The information processing method according to claim 13, further comprising:
registering, in a first storage circuit, the output of the training target model when the query and the first information are input to the training target model;
determining whether the output of the training target model is the correct answer to the query, when the query and the first information are input to the training target model;
registering, in a second storage circuit, second information, which is an output of the first storage device corresponding to the output of the training target model determined to be the correct answer to the query;
determining whether an output of the training target model is the correct answer to the query, when the query and the second information being registered in the second storage circuit are input to the training target model;
registering, in a third storage circuit, the output of the training target model determined to be the correct answer to the query; and
outputting, as the training data of the training target model, the query and the first information, the output of the training target model registered in the first storage circuit, and the output of the training target model registered in the third storage circuit.

16. The information processing method according to claim 15, further comprising:
determining whether the output of the training target model is the correct answer to the query by comparing the output of the training target model with ground truth information for the query, which is read from a second storage device configured to store the ground truth information.

17. The information processing method according to claim 15, further comprising:
registering an output of the training target model when a system prompt, which is instruction information for the training target model, the query, and the first information are input to the training target model;
determining whether the output of the training target model is the correct answer to the query, when the system prompt, the query, and the first information are input to the training target model;
registering third information, which is the output of the first storage device corresponding to the output of the training target model determined to be the correct answer to the query;
determining whether the output of the training target model is the correct answer to the query, when the system prompt, the query, and the third information are input to the training target model;
registering the output of the training target model determined to be the correct answer to the query; and
outputting, as the training data of the training target model, the system prompt, the query, the first information, the output of the training target model registered in the first storage circuit, and the output of the training target model registered in the third storage circuit.

18. The information processing method according to claim 15, further comprising:
acquiring a plurality of outputs of the first storage device with respect to the query from the first storage device;
registering a plurality of outputs of the training target model when the query and the plurality of outputs are input to the training target model; and
determining, for each of the plurality of outputs, whether an output of the training target model is the correct answer to the query, when the query and each of the plurality of outputs are set as separate sets and each set is input to the training target model.
